(19) United States
(12) Patent Application Publication
(10) Pub. No.: US 2010/0241297 A1
(43) Pub. Date: Sep. 23, 2010

(54) HYBRID VEHICLE AND CONTROL METHOD FOR HYBRID VEHICLE

(75) Inventors: Takanori Aoki, Nissin-shi (JP); Kazuyoshi Kamiya, Anjo-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi (JP)

(21) Appl. No.: 12/600,948

(22) PCT Filed: Nov. 26, 2008
(86) PCT No.: PCT/IB2008/003228

§ 371 Date: Nov. 19, 2009

(30) Foreign Application Priority Data
Nov. 27, 2007 (JP) 2007-305796

(51) Int. Cl. G06F 19/00

(52) U.S. Cl. 701/22; 180/65.265

(57) ABSTRACT

A running mode is determined on the basis of an input mode setting signal MSW. A lower intermittence prohibition vehicle speed is set when the running mode is a power mode than when the running mode is a normal mode. When a vehicle speed is equal to or higher than the set intermittence prohibition vehicle speed, an engine is prohibited from being operated intermittently. When the vehicle speed is not equal to or higher than the intermittence prohibition vehicle speed, a vehicle runs with the engine permitted to be operated intermittently. When the power mode is set, the engine is more often prohibited from being operated intermittently and hence is more often in operation. Therefore, the responsiveness of a driving force is enhanced. Further, when the normal mode is set, the engine is more often permitted to be operated intermittently. Therefore, no deterioration in fuel economy is caused.

### BACKGROUND OF THE INVENTION

1. Field of the Invention

The invention relates to a hybrid vehicle and a control method for a hybrid vehicle.

2. Description of the Related Art

There is proposed a vehicle having a plurality of modes in which different driving force characteristics are determined for the operation of an accelerator (e.g., see Japanese Patent Application Publication No. 2007-91073 (JP-A-2007-91073)). In this vehicle, a characteristic with larger driving force is adopted when a power mode is set than when a normal mode is set. As a result, high responsiveness can be obtained at the time of the power mode.

Further, there is proposed a hybrid vehicle having an internal combustion engine, electric power/motive power input/output means, and an electric motor that are controlled such that a driving force based on a required driving force is obtained with the internal combustion engine operated intermittently when the speed of the vehicle is lower than an intermittent operation prohibition vehicle speed, and are controlled such that a driving force based on a required driving force is obtained with the internal combustion engine operated when the speed of the vehicle is equal to or higher than the intermittent operation prohibition vehicle speed (e.g., Japanese Patent Application Publication No. 2007-31103 (JP-A-2007-31103)). In this vehicle, the internal combustion engine can be stopped when the speed of the vehicle is lower than the intermittent operation prohibition vehicle speed and the internal combustion engine does not need to be operated. Therefore, fuel economy can be improved.

In the vehicle disclosed in Japanese Patent Application Publication No. 2007-131103 (JP-A-2007-131103), the internal combustion engine needs to be started when the vehicle is accelerated with the internal combustion engine stopped and the speed of the vehicle becomes equal to or higher than the intermittent operation prohibition vehicle speed. Therefore, there is a problem in that “a feeling of limping along” is caused by a delay in the rising of a driving force during the start of the internal combustion engine. This problem is especially serious when greater importance is given to the responsiveness of the driving force of the vehicle as in the case of the power mode described in Japanese Patent Application Publication No. 2007-91073 (JP-A-2007-91073). On the other hand, good responsiveness of the driving force is obtained in the power mode if the internal combustion engine is not stopped. However, the internal combustion engine is driven in an idling state even when the operation thereof is unnecessary. Therefore, there is a problem in that fuel economy deteriorates in the normal mode.

### SUMMARY OF THE INVENTION

In view of the foregoing, the invention provides a hybrid vehicle and a control method for a hybrid vehicle that can eliminate “a feeling of limping along” during acceleration in a power mode and improve the responsiveness of a driving force without deteriorating fuel economy in a normal mode.

A hybrid vehicle according to a first aspect of the invention is equipped with an internal combustion engine, electric power/motive power input/output means, an electric motor, storage means, vehicle speed detection means, required driving force setting means, running mode setting means, vehicle speed threshold setting means, and control means. The electric power/motive power input/output means is connected to a drive shaft connected to wheels, and connected to an output shaft of the internal combustion engine rotatably independently of the drive shaft to input motive powers from the drive shaft and the output shaft and output motive powers to the drive shaft and the output shaft with an electric power and a motive power input/output. The electric motor inputs/outputs a motive power for running. The storage means exchanges electric powers with the electric power/motive power input/output means and the electric motor. The vehicle speed detection means detects a vehicle speed. The required driving force setting means sets a required driving force required for running. The running mode setting means sets a running mode from among a plurality of running modes including a normal mode and a power mode in which higher priority is given to responsiveness of a driving force than in the normal mode. In setting, on the basis of the running modes, a vehicle speed threshold as a boundary value between a stop permission vehicle speed range for permitting the internal combustion engine to be stopped and a stop prohibition vehicle speed range for prohibiting the internal combustion engine from being stopped, the vehicle speed threshold setting means sets the vehicle speed threshold smaller when the power mode is set than when the normal mode is set. The control means permits the internal combustion engine to be stopped and controls the internal combustion engine, the electric power/motive power input/output means, and the electric motor such that the vehicle runs by a driving force based on the set required driving force when the detected vehicle speed is included in the set stop permission vehicle speed range, and prohibits the internal combustion engine from being stopped and controls the internal combustion engine, the electric power/motive power input/output means, and the electric motor such that the vehicle runs by a driving force based on the set required driving force when the detected vehicle speed is included in the set stop prohibition vehicle speed range.

In this hybrid vehicle according to the first aspect of the invention, the vehicle speed threshold is set smaller when the power mode is set than when the normal mode is set in setting, on the basis of the running modes, the vehicle speed threshold as the boundary value between the stop permission vehicle speed range for permitting the internal combustion engine to be stopped and the stop prohibition vehicle speed range for prohibiting the internal combustion engine from being stopped. When the vehicle speed of the vehicle is included in the stop permission vehicle speed range, the internal combustion engine is permitted to be stopped. When the vehicle speed of the vehicle is included in the stop prohibition vehicle speed range, the internal combustion engine is prohibited from being stopped. Also, the internal combustion engine, the electric power/motive power input/output means, and the electric motor are controlled such that the vehicle runs by the set required driving force. In this manner, the vehicle speed is more often included in the stop prohibition vehicle speed range and the internal combustion engine is more often prohibited from being stopped in the power mode than in the normal mode. Accordingly, the internal combustion engine is often in operation during acceleration in the power mode. Therefore, “a feeling of limping along” is less often caused during acceleration, and the responsiveness of the driving force is enhanced. Further, the vehicle speed is more often included in the stop permission vehicle speed range and the internal combustion engine is more often permitted to be stopped in the normal mode than in the power mode. Accordingly, the internal combustion engine can be appropriately stopped in the normal mode when the operation of the internal combustion engine is unnecessary. As a result, no deterioration in fuel economy is caused.

The vehicle speed threshold setting means may set the vehicle speed threshold smaller when the internal combustion engine is in operation than when the internal combustion engine is stopped. In this manner, the internal combustion engine can be prevented from being operated and stopped frequently when the vehicle is running at a vehicle speed close to the vehicle speed threshold.

Further, the electric power/motive power input/output means may be equipped with an electric power generator capable of inputting/outputting a motive power, and three shaft-type motive power input/output means connected to the output shaft of the internal combustion engine, the drive shaft, and a rotary shaft of the electric power generator to input a motive power from one shaft or output a motive power to the one shaft, on the basis of motive powers input from or output to other two shafts among the three shafts.

Further, the hybrid vehicle may be equipped with a running mode setting switch, and the running mode setting means may set a running mode in accordance with an operation of the running mode setting switch.

Further, the running mode setting means may make a changeover in the running mode depending on whether or not at least one of a value of an accelerator operation amount, an amount of change in the accelerator operation amount, an average of a vehicle speed V, and an amount of change in the average of the vehicle speed V has exceeded a certain value.

Further, the vehicle speed threshold setting means may set a predetermined vehicle speed threshold for each of the running modes.

Further, the vehicle speed threshold setting means may set the vehicle speed threshold on the basis of input/output limits of a battery.

A second aspect of the invention relates to a control method for a hybrid vehicle equipped with an internal combustion engine, electric power/motive power input/output means, an electric motor, storage means, vehicle speed detection means, and running mode setting means. The electric power/motive power input/output means is connected to a drive shaft connected to wheels, and connected to, an output shaft of the internal combustion engine rotatably independently of the drive shaft to input motive powers from the drive shaft and the output shaft and output motive powers to the drive shaft and the output shaft with an electric power and a motive power input/output. The electric motor inputs/outputs a motive power for running. The storage means exchanges electric powers with the electric power/motive power input/output means and the electric motor. The vehicle speed detection means detects a vehicle speed. The running mode setting means sets a running mode from among a plurality of running modes including a normal mode and a power mode in which higher priority is given to responsiveness of a driving force than in the normal mode. The control method includes setting a vehicle speed threshold, which is a boundary value between a stop permission vehicle speed range for permitting the internal combustion engine to be stopped and a stop prohibition vehicle speed range for prohibiting the internal combustion engine from being stopped, smaller when the power mode is set than when the normal mode is set in setting the vehicle speed threshold on the basis of the running modes, permitting the internal combustion engine to be stopped and controlling the internal combustion engine, the electric power/motive power input/output means, and the electric motor such that the vehicle runs by a driving force based on a required driving force required for running when the detected vehicle speed is included in the set stop permission vehicle speed range, and prohibiting the internal combustion engine from being stopped and controlling the internal combustion engine, the electric power/motive power input/output means, and the electric motor such that the vehicle runs by a driving force based on the required driving force when the detected vehicle speed is included in the set stop prohibition vehicle speed range.

In this control method for the hybrid vehicle according to the second aspect of the invention, the vehicle speed threshold is set smaller when the power mode is set than when the normal mode is set in setting, on the basis of the running modes, the vehicle speed threshold as the boundary value between the stop permission vehicle speed range for permitting the internal combustion engine to be stopped and the stop prohibition vehicle speed range for prohibiting the internal combustion engine from being stopped. When the vehicle speed of the vehicle is included in the stop permission vehicle speed range, the internal combustion engine is permitted to be stopped. When the vehicle speed of the vehicle is included in the stop prohibition vehicle speed range, the internal combustion engine is prohibited from being stopped. Also, the internal combustion engine, the electric power/motive power input/output means, and the electric motor are controlled such that the vehicle runs by the set required driving force. In this manner, the vehicle speed is more often included in the stop prohibition vehicle speed range and the internal combustion engine is more often prohibited from being stopped in the power mode than in the normal mode. Accordingly, the internal combustion engine is more often in operation during acceleration in the power mode. Therefore, “a feeling of limping along” is less often caused during acceleration, and the responsiveness of the driving force is enhanced. Further, the vehicle speed is more often included in the stop permission vehicle speed range and the internal combustion engine is more often permitted to be stopped in the normal mode than in the power mode. Accordingly, the internal combustion engine can be appropriately stopped in the normal mode when the operation of the internal combustion engine is unnecessary. As a result, no deterioration in fuel economy is caused.

### BRIEF DESCRIPTION OF THE DRAWINGS

The foregoing and further features and advantages of the invention will become apparent from the following description of an example embodiment with reference to the accompanying drawings, wherein like numerals are used to represent like elements, and wherein:

FIG. 1 is a schematic diagram showing the outline of the configuration of a hybrid automobile 20;

FIGS. 2A-2B are flowcharts showing an example of a driving control routine executed by a hybrid electronic control unit 70 according to the embodiment of the invention;

FIG. 3 is a flowchart showing an example of an intermittence prohibition vehicle speed setting routine executed by the hybrid electronic control unit 70 according to the embodiment of the invention;

FIGS. 4A-4B are illustrative views showing relationships among intermittence prohibition vehicle speeds Vstop and Vstart and V1 to V4;

FIG. 5 is an illustrative view showing an example of a required torque setting map;

FIG. 6 is an illustrative view showing an example of an operation line of an engine 22 and how a target rotational speed Ne* and a target torque Te* are set;

FIG. 7 is an illustrative view showing an example of an alignment chart showing a mechanical relationship between rotational speed and torque in rotational elements of a motive power distribution/synthesis mechanism 30 when the hybrid automobile 20 is running with a power output from the engine 22;

FIG. 8 is an illustrative view showing how torque limits Tm1min and Tm1max are set;

FIG. 9 is an illustrative view showing an example of an alignment chart showing a mechanical relationship between rotational speed and torque in the rotational elements of the motive power distribution/synthesis mechanism 30 when the hybrid automobile 20 is running with the engine 22 stopped from being operated;

FIG. 10 is an illustrative view showing an example of an alignment chart showing a mechanical relationship between rotational speed and torque in the rotational elements of the motive power distribution/synthesis mechanism 30 when the hybrid automobile 20 is running with the engine 22 in a motoring state;

FIG. 11 is a schematic diagram showing the outline of the configuration of a hybrid automobile 120 according to a modification example of the embodiment of the invention; and

FIG. 12 is a schematic diagram showing the outline of the configuration of a hybrid automobile 220 according to another modification example of the embodiment of the invention.

### DETAILED DESCRIPTION OF EMBODIMENT

Next, the best mode for implementing the invention will be described using the embodiment thereof.

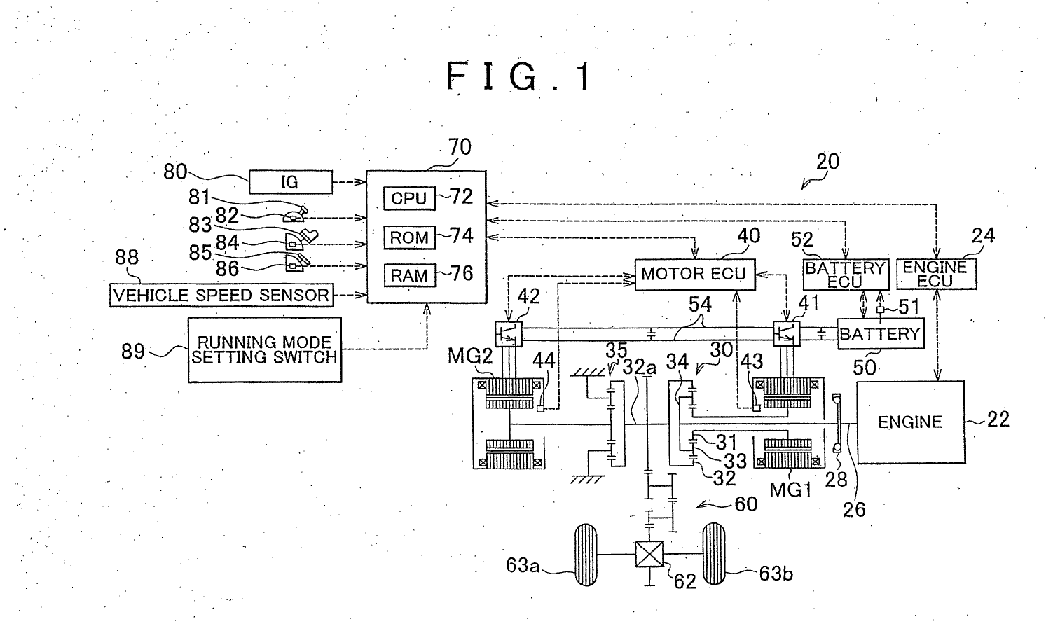

FIG. 1 is a schematic diagram showing the outline of the configuration of a hybrid automobile 20 according to one embodiment of the invention. As shown in FIG. 1, the hybrid automobile 20 according to the embodiment of the invention is equipped with an engine 22, a three shaft-type motive power distribution/synthesis mechanism 30 connected to a crankshaft 26 as an output shaft of the engine 22 via a damper 28, a motor MG1 connected to the motive power distribution/synthesis mechanism 30 and capable of generating electric power, a reduction gear 35 mounted on a ring gear shaft 32a as a drive shaft connected to the Motive power distribution/synthesis mechanism 30, a motor MG2 connected to this reduction gear 35, and a hybrid electronic control unit 70 for controlling an entire motive power output device.

The engine 22 is an internal combustion engine that outputs a motive power using a hydrocarbon-type fuel, for example, gasoline, diesel oil, or the like. The engine 22 is subjected to various types of operation control such as fuel injection control, ignition control, intake air amount adjustment control, and the like by an engine electronic control unit (hereinafter referred to as the engine ECU) 24. Signals from various sensors for detecting an operation state of the engine 22, for example, a crank position from a crank position sensor (not shown) for detecting a crank angle of a crankshaft 26 of the engine 22 and the like are input to the engine ECU 24. Further, the engine ECU 24 is in communication with a hybrid electronic control unit 70, and controls the operation of the engine 22 in accordance with a control signal from the hybrid electronic control unit 70. When necessary, the engine ECU 24 outputs data on the operation state of the engine 22 to the hybrid electronic control unit 70. The engine ECU 24 also calculates a rotational speed of the crankshaft 26, namely, a rotational speed Ne of the engine 22 on the basis of a crank position from the crank position sensor (not shown).

The motive power distribution/synthesis mechanism 30 is equipped with a sun gear 31 as an external gear, a ring gear 32 as an internal gear disposed concentrically with this sun gear 31, a plurality of pinion gears 33 meshing with the sun gear 31 and the ring gear 32, and a carrier 34 for holding the plurality of the pinion gears 33 such that these pinion gears 33 can rotate on their own axes respectively and around the carrier 34. The motive power distribution/synthesis mechanism 30 is constituted as a planetary gear mechanism for performing a differential operation with the sun gear 31, the ring gear 32, and the carrier 34 serving as rotational elements. In the motive power distribution/synthesis mechanism 30, the crankshaft 26 of the engine 22 is coupled to the carrier 34, the motor MG1 is coupled to the sun gear 31, and the reduction gear 35 is coupled to the ring gear 32 via the ring gear shaft 32a. When the motor MG1 functions as an electric power generator, a motive power from the engine 22, which is input from the carrier 34, is distributed to the sun gear 31 side and the ring gear 32 side according to a gear ratio therebetween. When the motor MG1 functions as an electric motor, a motive power from the engine 22, which is input from the carrier 34, and a motive power from the motor MG1, which is input from the sun gear 31, are synthesized with each other to be output to the ring gear 32 side. The motive power output to the ring gear 32 is eventually output from the ring gear shaft 32a to driving wheels 63a and 63b of a vehicle via a gear mechanism 60 and a differential gear 62.

Each of both the motors MG1 and MG2 is constructed as a known synchronous electric power generation motor that can be driven as an electric power generator and an electric motor. The motors MG1 and MG2 exchange an electric power with a battery 50 via inverters 41 and 42 respectively. Electric power lines 54 for connecting the inverters 41 and 42 to the battery 50 are constructed as a positive bus and a negative bus, which are commonly used by the respective inverters 41 and 42, such that an electric power generated by one of the motors MG1 and MG2 can be consumed by the other motor. Accordingly, the battery 50 is charged/discharged through an electric power generated by one of the motors MG1 and MG2 or due to a deficiency in electric power. If the input of electric power and the output of electric power are balanced with each other by the motors MG1 and MG2, the battery 50 is not charged/discharged. The motors MG1 and MG2 are both drivingly controlled by a motor electronic control unit (hereinafter referred to as the motor ECU) 40. Signals necessary for the driving control of the motors MG1 and MG2, for example, signals from rotational position detection sensors 43 and 44 for detecting rotational positions of rotors of the motors MG1 and MG2, signals from current sensors (not shown) for detecting phase currents applied to the motors MG1 and MG2, and the like are input to the motor ECU 40. Switching control signals for the inverters 41 and 42 are output from the motor ECU 40. The motor ECU 40 is in communication with the hybrid electronic control unit 70, and drivingly controls the motors MG1 and MG2 in accordance with a control signal from the hybrid electronic control unit 70. When necessary, the motor ECU 40 outputs data on the operation states of the motors MG1 and MG2 to the hybrid electronic control unit 70. The motor ECU 40 also calculates rotational speeds Nm1 and Nm2 of the motors MG1 and MG2 on the basis of signals from the rotational position detection sensors 43 and 44 respectively.

The battery 50 is supervised by a battery electronic control unit (hereinafter referred to as the battery ECU) 52. Signals necessary for the supervision of the battery 50, for example, an inter-terminal voltage from a voltage sensor (not shown) installed between terminals of the battery 50, a charge/discharge current from a current sensor (not shown) fitted to the electric power lines 54 connected to the output terminal of the battery 50, a battery temperature Tb from a temperature sensor 51 fitted to the battery 50, and the like are input to the battery ECU 52. When necessary, the battery ECU 52 outputs data on the state of the battery 50 to the hybrid electronic control unit 70 through communication. Further, the battery ECU 52 calculates a remaining capacity (SOC) on the basis of an integrated value of a charge/discharge current detected by the current sensor to supervise the battery 50, and calculates an input limit Win and an output limit Wout as maximum permissible electric powers with/of which the battery 50 may be charged/discharged, on the basis of the calculated remaining capacity (SOC) and the battery temperature Tb.

The hybrid electronic control unit 70 is constructed as a micro processor mainly composed of a CPU 72, and is equipped with a ROM 74 for storing processing programs, a RAM 76 for temporarily storing data, input/output ports (not shown), and communication ports (not shown) in addition to the CPU 72. An ignition signal from an ignition switch 80, a shift position SP from a shift position sensor 82 for detecting an operation position of a shift lever 81, an accelerator operation amount Acc from an accelerator pedal position sensor 84 for detecting a depression amount of an accelerator pedal 83, a brake pedal position BP from a brake pedal position sensor 86 for detecting a depression amount of a brake pedal 85, a vehicle speed V from a vehicle speed sensor 88, a mode setting signal MSW from a running mode setting switch 89 for setting a running mode to a normal mode or a power mode, in which priority is given to the responsiveness of a driving force, through the operation by a driver, and the like are input to the hybrid electronic control unit 70 via the input ports. As described above, the hybrid electronic control unit 70 is connected to the engine ECU 24, the motor ECU 40, and the battery ECU 52 via the communication ports, and exchanges various control signals and various data with the engine ECU 24, the motor ECU 40, and the battery ECU 52.

In the hybrid automobile 20 according to the embodiment of the invention, a required torque Tr* to be output to the ring gear shaft 32a as the drive shaft is calculated on the basis of the accelerator operation amount Acc, which corresponds to the amount of depression of the accelerator pedal 83 by the driver, and the vehicle speed V, and the engine 22 and the motors MG1 and MG2 are operationally controlled such that a required motive power corresponding to this required torque Tr* is output to the ring gear shaft 32a. In operationally controlling the engine 22 and the motors MG1 and MG2, there are a torque conversion operation mode, a charge/discharge operation mode, a motor operation mode, and the like. In the torque conversion operation mode, the engine 22 is operationally controlled such that a motive power corresponding to the required motive power is output from the engine 22, and the motors MG1 and MG2 are drivingly controlled such that the motive power output from the engine 22 is entirely subjected to torque conversion by the motive power distribution/synthesis mechanism 30 and the motors MG1 and MG2 and output to the ring gear shaft 32a. In the charge/discharge operation mode, the engine 22 is operationally controlled such that a motive power corresponding to the sum of the required motive power and an electric power necessary for the charge/discharge of the battery 50 is output from the engine 22, and the motors MG1 and MG2 are drivingly controlled such that the motive power output from the engine 22 with the charging/discharging of the battery 50 is entirely or partially subjected to torque conversion by the motive power distribution/synthesis mechanism 30 and the motors MG1 and MG2 and the required motive power is output to the ring gear shaft 32a. In the motor operation mode, the operation of the engine 22 is stopped, and the engine 22 and the motors MG1 and MG2 are operationally controlled such that the motive power corresponding to the required motive power, which is obtained from the motor MG2, is output to the ring gear shaft 32a.

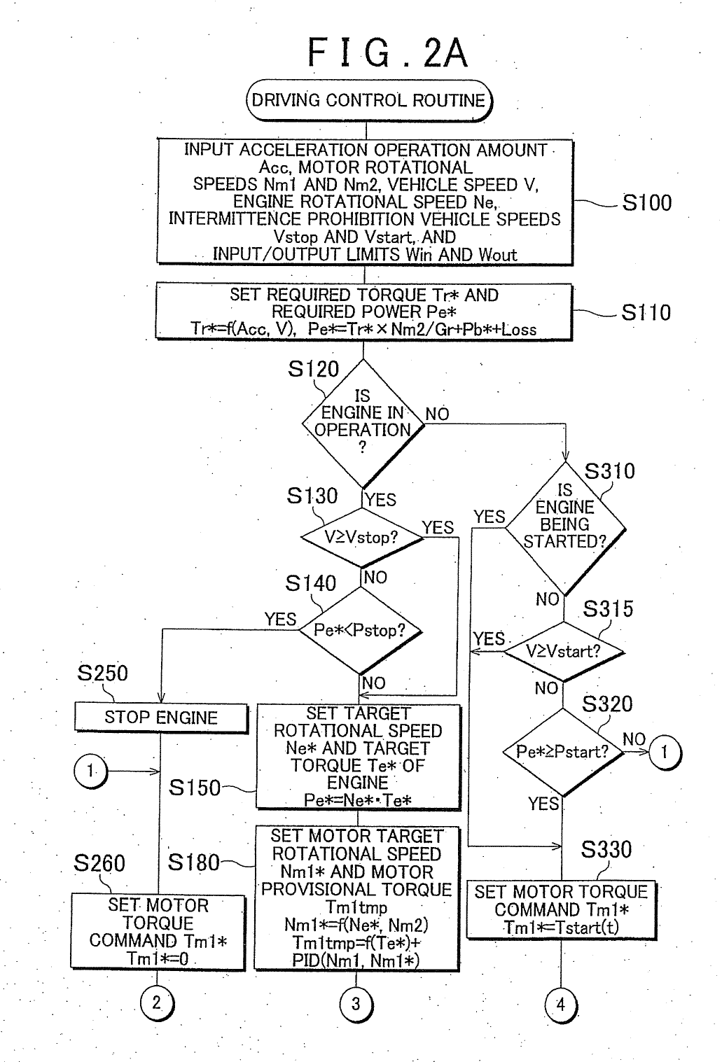

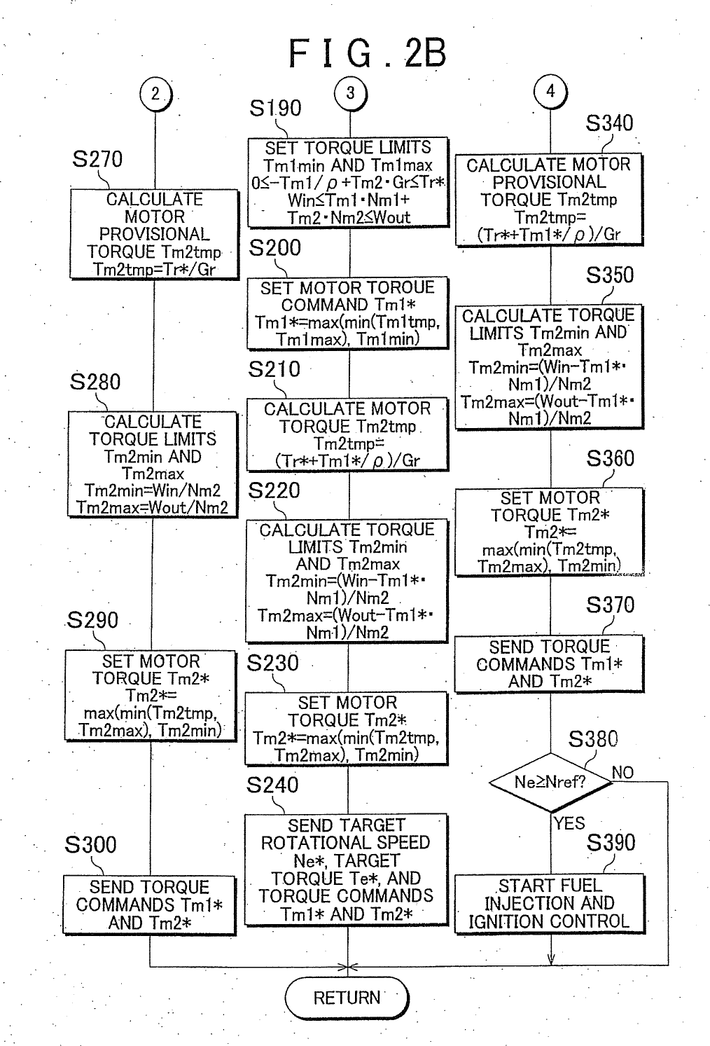

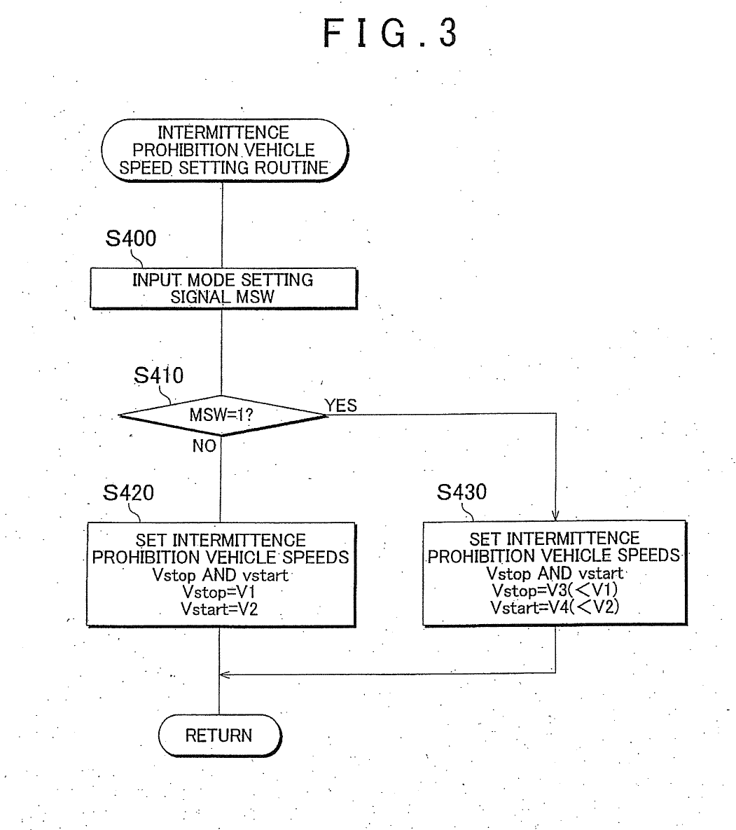

Next, the operation of the hybrid automobile 20 thus configured according to this embodiment of the invention will be described. FIGS. 2A-2B are flowcharts showing an example of a driving control routine executed by the hybrid electronic control unit 70. FIG. 3 is a flowchart showing an example of an intermittence prohibition vehicle speed setting routine for setting intermittence prohibition vehicle speeds Vstop and Vstart that are used in the driving control routine. The intermittence prohibition vehicle speed Vstop is a boundary value between an intermittence permission vehicle speed range in which the engine is permitted to be operated intermittently during the operation thereof and an intermittence prohibition vehicle speed range in which the engine 22 is prohibited from being operated intermittently during the operation thereof. The intermittence prohibition vehicle speed Vstart is a boundary value between an intermittence permission vehicle speed range in which the engine 22 is permitted to be operated intermittently during the stoppage thereof and an intermittence prohibition vehicle speed range in which the engine 22 is prohibited from being operated intermittently during the stoppage thereof. Each of the driving control routine and the intermittence prohibition vehicle speed setting routine is repeatedly executed at intervals of a predetermined time (e.g. at intervals of several milliseconds). For convenience of explanation, a processing of setting the intermittence prohibition vehicle speeds Vstart and Vstop will be described first using the intermittence prohibition vehicle speed setting routine of FIG. 3, and after that, driving control will be described using the driving control routine of FIGS. 2A-2B.

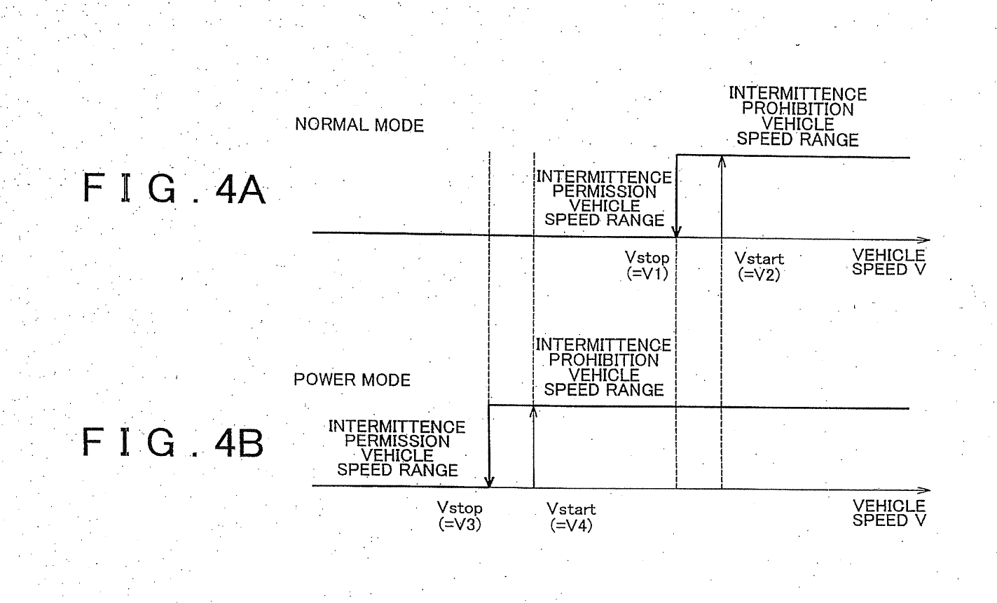

When the intermittence prohibition vehicle speed setting routine of FIG. 3 is executed, the CPU 72 of the hybrid electronic control unit 70 first performs a processing of inputting the mode setting signal MSW from the running mode setting switch 89 (step S400). The CPU 72 then checks the value of the mode setting signal MSW (step S410). The value of the mode setting signal MSW is set to 0 when the normal mode is set by the running mode setting switch 89, and is set to 1 when the power mode is set by the running mode setting switch 89. When the value of MSW is 0 in step S410, namely, when the running mode is the normal mode, the CPU 72 sets the values of the intermittence prohibition vehicle speeds Vstop and Vstart to V1 and V2 respectively (step S420), thereby terminating the present routine. On the other hand, when the value of MSW is 1 in step S410, namely, when the running mode is the power mode, the CPU 72 sets the values of the intermittence prohibition vehicle speeds Vstop and Vstart to V3 and V4 respectively (step S430), thereby terminating the present routine. FIGS. 4A-4B are illustrative views showing relationships among the intermittence prohibition vehicle speeds Vstop and Vstart set in the present routine and the values V1 to V4. It should be noted that the values V1 and V2 are experimentally determined such that fuel economy and the responsiveness of a driving force are maintained in a well balanced manner when the values V1 and V2 are set as the intermittence prohibition vehicle speeds Vstop and Vstart respectively and the later-described driving control routine is executed. The values V3 and V4 are set smaller than the values V1 and V2 respectively such that high responsiveness of a driving force as required in the power mode is obtained when the values V3 and V4 are set as the intermittence prohibition vehicle speeds Vstop and Vstart respectively and the later-described driving control routine is executed. Further, in order to prevent the engine 22 from being operated and stopped frequently when the later-described driving control routine is executed, values larger than the values V1 and V3 may be used as the values V2 and V4 respectively.

Next, the driving control performed using the intermittence prohibition vehicle speeds Vstop and Vstart thus set will be described. When the driving control routine of FIGS. 2A-2B is executed, the CPU, 72 of the hybrid electronic control unit 70 first performs a processing of inputting data required for the control, such as the accelerator operation amount Acc from the accelerator pedal position sensor 84, the vehicle speed V from the vehicle speed sensor 88, the rotational speed Ne of the engine 22, the rotational speeds Nm1 and Nm2 of the motors MG1 and MG2, the intermittence prohibition vehicle speeds Vstop and Vstart, the input/output limits Win and Wout of the battery 50, and the like (step S100). It should be noted herein that the rotational speed Ne of the engine 22 is calculated, on the basis of a signal from the crank position sensor (not shown) and then input through communication from the engine ECU 24. Further, the rotational speeds Nm1 and Nm2 of the motors MG1 and MG2 are calculated on the basis of rotational positions of the rotors of the motors MG1 and MG2 detected by the rotational position detection sensors 43 and 44 and then input through communication from the motor ECU 40. Furthermore, the input/output limits Win and Wout of the battery 50 are set on the basis of the battery temperature Tb of the battery 50 and the remaining capacity (SOC) of the battery 50 and then input through communication from the battery ECU 52. The intermittence prohibition vehicle speeds Vstop and Vstart are set by the aforementioned intermittence prohibition vehicle speed setting routine exemplified in FIG. 3 and then input.

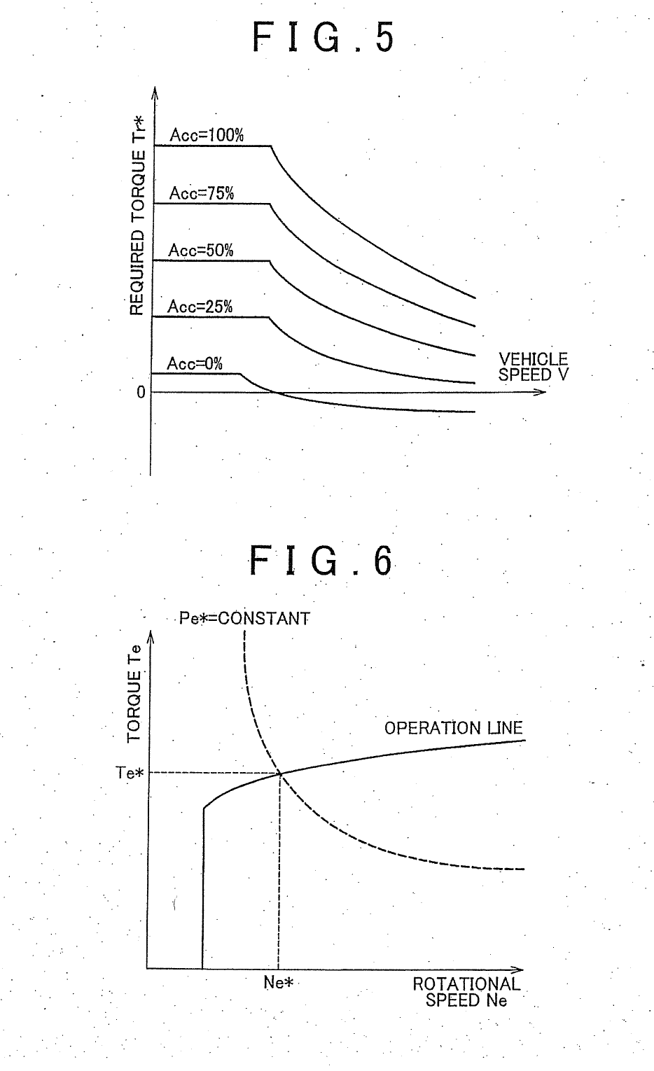

When the data are thus input, the CPU 72 sets, as torques required for the vehicle, the required torque Tr* to be output to the ring gear shaft 32a as the drive shaft coupled to the driving wheels 63a and 63b and a required power Pe* required for the engine 22, on the basis of the input accelerator operation amount Acc and the input vehicle speed V (step S110). In the embodiment of the invention, the required torque Tr* is set by determining in advance a relationship among the accelerator operation amount Acc, the vehicle speed V, and the required torque Tr*, storing this relationship into the ROM 74 as a required torque setting map, and deriving a corresponding value of the required torque Tr* from the stored map when the accelerator operation amount Acc and the vehicle speed V are given. FIG. 5 shows an example of the required torque setting map. The required power Pe* can be calculated as the sum of a value obtained by multiplying a set required torque Tr* by a rotational speed Nr of the ring gear shaft 32a, a charge/discharge required power Pb* required by the battery 50, and a loss Loss. The rotational speed Nr of the ring gear shaft 32a can be calculated by multiplying the vehicle speed V by a conversion coefficient k (Nr=k·V) or dividing the rotational speed Nm2 of the motor MG2 by a gear ratio Gr of the reduction gear 35 (Nr=Nm2/Gr).

The CPU 72 then determines whether or not the engine 22 is in operation (step S120). When the engine 22 is in operation, the CPU 72 determines whether or not the vehicle speed V is equal to or higher than the intermittence prohibition vehicle speed Vstop (step S130) in order to determine whether to permit the engine 22 to be operated intermittently or not. When the vehicle speed V is equal to or higher than the intermittence prohibition vehicle speed Vstop, namely, when the vehicle speed V is included in the intermittence prohibition vehicle speed range as a range of high vehicle speed with the intermittence prohibition vehicle speed Vstop shown in FIGS. 4A and 4B serving as a boundary value, the CPU 72 prohibits the engine 22 from being operated intermittently and determines that the engine 22 should be operated continuously without being stopped. On the other hand, when the vehicle speed V is not equal to or higher than the intermittence permission vehicle speed Vstop, namely, when the vehicle speed V is included in the intermittence prohibition vehicle speed range as a range of low vehicle speed with the intermittence prohibition vehicle speed. Vstop shown in FIGS. 4 A and 4B serving as a boundary value, the CPU 72 permits the engine 22 to be operated intermittently and determines that the engine 22 can be stopped. It should be noted herein that the aforementioned intermittence prohibition vehicle speed setting routine sets the intermittence prohibition vehicle speed Vstop to the value V1 when the running mode is the normal mode, and to the value V3 when the running mode is the power mode. As shown in FIGS. 4A and 4B, the value V3 is smaller than the value V1. Therefore, the intermittence prohibition vehicle speed range is wider when the running mode is the power mode than when the running mode is the normal mode. Accordingly, the vehicle speed V is often equal to or higher than the intermittence prohibition vehicle speed Vstop even when it is low, and the CPU 72 often determines that the engine 22 should be operated continuously.

When the vehicle speed V is equal to or higher than the intermittence prohibition vehicle speed Vstop in step S130, the CPU 72 sets a target rotational speed Ne* and a target torque Te* as operation points where the engine 22 should be operated, on the basis of the required power Pe* set in step S110 (step S150). This setting is carried out on the basis of an operation line for efficiently operating the engine 22 and the required power Pe*. FIG. 6 shows an example of the operation line of the engine 22 and how the target rotational speed Ne* and the target torque Te* are set. As shown in FIG. 6, each of the target rotational speed Ne* and the target torque Te* are calculated as an intersecting point between a curve where the required power Pe* (=Ne*×Te*) is constant and the operation line.

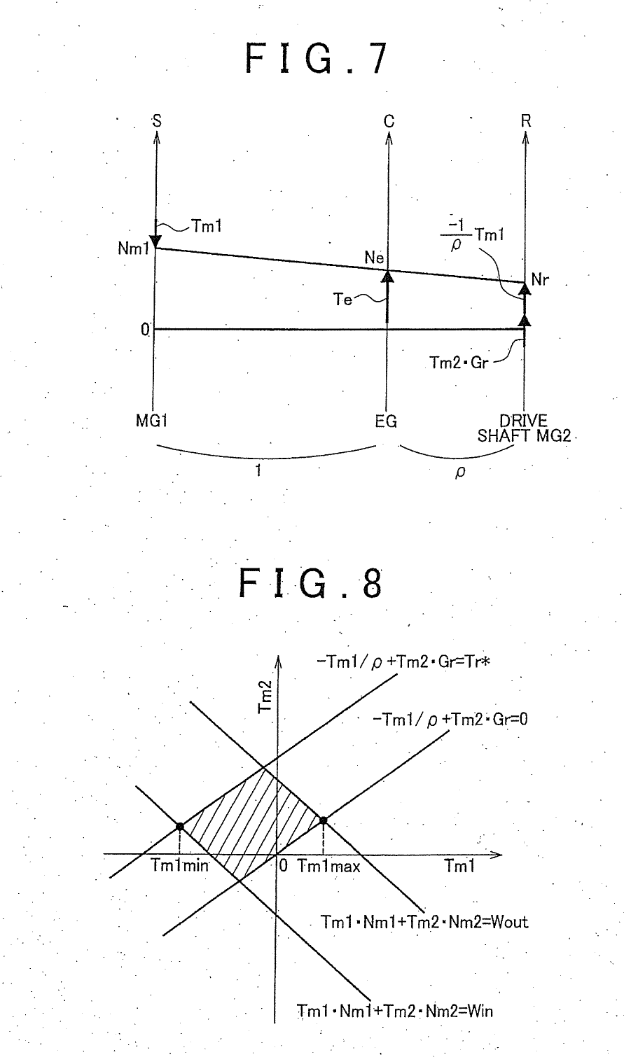

The CPU 72 then calculates the target rotational speed Nm1* of the motor MG1 according to an expression (1) shown below using the target rotational speed Ne* of the engine 22, the rotational speed Nm2 of the motor MG2, a gear ratio ρ of the motive power distribution/synthesis mechanism 30, and a gear ratio ρ of the reduction gear 35, and calculates a provisional torque Tm1tmp as a provisional value of a torque to be output from the motor MG1 according to an expression (2) shown below on the basis of the calculated target rotational speed Nm1* and the input rotational speed Nm1 of the motor MG1 (step S180). It should be noted herein that the expression (1) is a mechanical relational expression for the rotational elements of the motive power distribution/synthesis mechanism 30. FIG. 7 is an alignment chart showing a mechanical relationship between rotational speed and torque in the rotational elements of the motive power distribution/synthesis mechanism 30 when the hybrid automobile is running with a power output from the engine 22. In FIG. 7, an S axis on the left represents the rotational speed of the sun gear 31 as the rotational speed Nm1 of the motor MG1, a C axis at the center represents the rotational speed of the carrier 34 as the rotational speed Ne of the engine 22, and an R axis on the right represents the rotational speed Nr of the ring gear 32, which is obtained by dividing the rotational speed Nm2 of the motor MG2 by the gear ratio Gr of the reduction gear 35. The expression (1) can be derived easily if this alignment chart is used. Two thick arrows on the R axis indicate a torque acting on the ring gear shaft 32a as the torque Tm1 output from the motor MG1 and a torque acting on the ring gear shaft 32a via the reduction gear 35 as the torque Tm2 output from the motor MG2. Further, the expression (2) is a relational expression in feedback control for rotating the motor MG1 at the target rotational speed Nm1*. In the expression (2), “k1” in the second term of the right side denotes a gain of a proportional term, and “k2” in the third term of the right side denotes a gain of an integral term.

Nm1*=Ne*·(1+ρ)/ρ−Nm2/(Gr·ρ) (1)

Tm1tmp=ρ·Te*/(1−ρ)+k1(Nm1*−Nm1)+k2(Nm1*−Nm1)dt (2)

The CPU 72 then sets torque limits Tm1min as a lower limit of the provisional torque Tm1tmp and Tm1max as an upper limit of the provisional torque Tm1tmp, which satisfy both the expressions (3) and (4) (step S190), and sets the torque command Tm1* of the motor MG1 by limiting the set provisional torque Tm1tmp by the torque limits Tm1min and Tm1max according to an expression (5) (step S200). It should be noted herein that the expression (3) represents a relationship where the sum of torques output to the ring gear shaft 32a by the motors MG1 and MG2 is within a range from the value of 0 to the required torque Tr*, and that the expression (4) represents a relationship where the sum of the electric powers input/output by the motors MG1 and MG2 is within a range between the input/output limits Win and Wout. FIG. 8 shows an example of the torque limits Tm1min and Tm1max. The torque limits Tm1min and Tm1max can be calculated respectively as a maximum of the torque command Tm1* and a minimum of the torque command Tm1* within a hatched region in FIG. 8.

0≦−Tm1/ρ+Tm2·Gr≦Tr* (3)

Win≦Tm1·Nm1+Tm2·Nm2≦Wout (4)

Tm1*=max(min(Tm1tmp,Tm1max),Tm1min) (5)

The CPU 72 then calculates a provisional torque Tm2tmp as a provisional value' of the torque to be output from the motor MG2 according to an expression (6) shown below (step 5210) by adding to the required torque Tr* a value obtained by dividing the torque Tm1* by the gear ratio ρ of the motive power distribution/synthesis mechanism 30, calculates torque limits Tm2 min and Tm2max as a lower, limit of torque and an upper limit of torque which may be output from the motor MG2 according to expressions (7) and (8) shown below (step S220) by dividing differences between the input/output limits Win and Wout of the battery 50 and an electric power consumption (generated electric power) of the motor MG1, which is obtained by multiplying the set torque command Tm1* by the current rotational speed Nm1 of the motor MG1, by the rotational speed Nm2 of the motor MG2, and sets the torque command Tm2* of the motor MG2 (step S230) by limiting the set provisional torque Tm2tmp by the torque limits Tm2min and Tm2max according to an expression (9). It should be noted herein that the expression (6) can be easily derived from the alignment chart of FIG. 7.

Tm2tmp=(Tr*+Tm1tmp/ρ)/Gr (6)

Tm2min=(Win−Tm1*·Nm1)/Nm2 (7)

Tm2max=(Wout−Tm1*·Nm1)/Nm2 (8)

Tm2*=max(min(Tm2tmp, Tm2max), Tm2min) (9)

When the target rotational speed Ne* of the engine 22, the target torque Te* of the engine 22, the torque command Tm1* of the motor MG1, and the torque command Tm2* of the motor MG2 are thus set, the CPU 72 sends the target rotational speed Ne* of the engine 22 and the target torque Te* of the engine 22 to the engine ECU 24, and the torque command Tm1* of the motor MG1 and the torque command Tm2* of the motor MG2 to the motor ECU 40 (step S240), thereby terminating the present routine. The engine ECU 24, which has received the target rotational speed Ne* and the target torque Te*, performs various kinds of control such as intake air amount control, fuel injection control, ignition control, and the like such that the engine 22 is operated at the operation point indicated by the target rotational speed Ne* and the target torque Te*. Further, the motor ECU 40, which has received the torque commands Tm1* and Tm2*, performs switching control of the switching elements of the inverters 41 and 42 such that the motor. MG1 is driven with the torque command Tm1* and that the motor MG2 is driven with the torque command Tm2*. Owing to this control, the hybrid automobile 20 can run with the engine 22 efficiently operated within the input/output limits Win and Wout of the battery 50 and the torque based on the required torque Tr* output to the ring gear shaft 32a as the drive shaft.

When the vehicle speed V is not equal to or higher than the intermittence prohibition vehicle speed Vstop in step S130, the CPU 72 permits the engine 22 to be operated intermittently, and determines whether or not the set required power Pe* is smaller than a threshold Pstop for stopping the engine 22 (step S140) in order to determine whether to continue the operation of the engine 22 or not. When it is determined that the set required power Pe* is not smaller than the threshold Pstop, the CPU 72 determines that the engine 22 should not be stopped, and performs the processings of the aforementioned steps S150 to 5240. It should be noted herein that a value in the neighborhood of a lower limit of a power region where the engine 22 can be operated relatively efficiently can be used as the threshold Pstop.

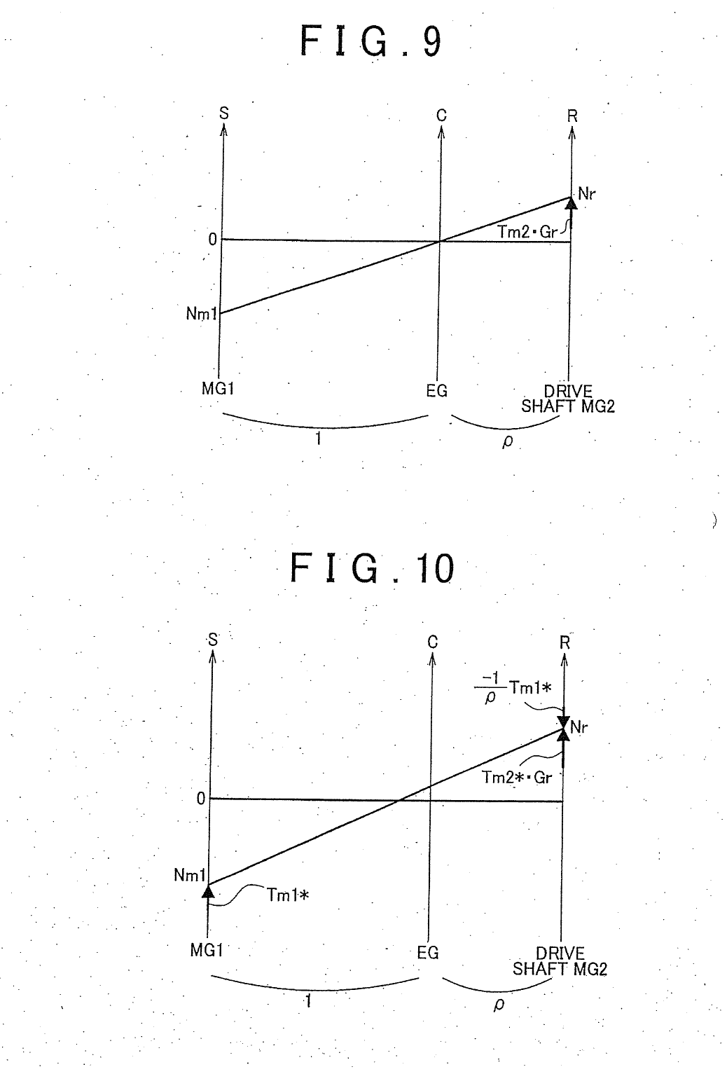

When it is determined in step S130 that the vehicle speed V is not equal to or higher than the intermittence prohibition vehicle speed Vstop and it is determined in step S140 that the required power Pe* is smaller than the threshold Pstop, the CPU 72 permits the engine 22 to be operated intermittently, determines that the engine 22 should be stopped from being operated, sends a control signal for stopping the operation of the engine 22 by stopping fuel injection control and ignition control to the engine ECU 24 to stop the engine 22 (step S250), and sets the torque command Tm1* of the motor MG1 to the value of 0 (step S260). The CPU 72 then sets the provisional torque Tm2tmp as a provisional value of the torque to be output from the motor MG2 to a value obtained by dividing the required torque Tr* by the gear ratio Gr of the reduction gear 35 (step S270), substitutes the value of 0 for the torque command Tm1* in the aforementioned expressions (7) and (8) to calculate the torque limits Tm2 min and Tm2max of the motor MG2 (step S280), limits the provisional torque Tm2tmp by the torque limits Tm2 min and Tm2max according to the expression (9) to set the torque command Tm2* of the motor MG2 (step S290), and sends the set torque commands Tm1* and Tm2* to the motor ECU 40 (step S300), thereby terminating the present routine. Owing to this control, the hybrid automobile 20 can run with the engine 22 stopped from being operated and with the required torque Tr* output from the motor MG2 to the ring gear shaft 32a as the drive shaft within the range between the input/output limits Win and Wout of the battery 50. FIG. 9 is an alignment chart showing a mechanical relationship between rotational speed and torque in the rotational elements of the motive power distribution/synthesis mechanism 30 at the time when the hybrid automobile 20 is running with the engine 22 stopped from being operated.

When it is determined in step S120 that the engine 22 is not in operation, the CPU 72 determines whether or not the engine 22 is being started (step S310). When the engine 22 is not being started, the CPU 72 determines whether or not the vehicle speed V is equal to or higher than the intermittence prohibition vehicle speed Vstart (step S315) in order to determine whether or not the engine should be started. When the vehicle speed V is equal to or higher than the intermittence prohibition vehicle speed Vstart, namely, when the vehicle speed V is included in the intermittence prohibition vehicle speed range as a range of high vehicle speed with the intermittence prohibition vehicle speed Vstart shown in FIGS. 4A and 4B serving as a boundary value, the CPU 72 prohibits the engine 22 from being operated intermittently, and determines that the stopped engine 22 should be started. On the other hand, when the vehicle speed V is not equal to or higher than the intermittence prohibition vehicle speed Vstart, namely, when the vehicle speed V is included in the intermittence permission vehicle speed range as a range of low vehicle speed with the intermittence prohibition vehicle speed Vstart shown in FIGS. 4A and 4B serving as a boundary value, the CPU 72 permits the engine 22 to be operated intermittently, and determines that the engine 22 can be stopped continuously. It should be noted herein that the aforementioned intermittence prohibition vehicle speed setting routine sets the intermittence prohibition vehicle speed Vstart to the value V2 when the running mode is the normal mode, and to the value V4 when the running mode is the power mode. As shown in FIGS. 4A and 4B, the value V4 is smaller than the value V2. Therefore, the intermittence prohibition vehicle speed range is wider when the running mode is the power mode than when the running mode is the normal mode. Accordingly, the vehicle speed V is often equal to or higher than the intermittence prohibition vehicle speed Vstart even when it is low, and the CPU 72 often determines that the stopped engine 22 should be started.

When the vehicle speed V is not equal to or higher than the intermittence prohibition vehicle speed Vstart in step S315, the CPU 72 permits the engine 22 to be operated intermittently, and determines whether or not the set required power Pe* is equal to or larger than a threshold Pstart for starting the engine 22 (step S320) in order to determine whether or not the engine 22 should be stopped continuously. When the required power Pe* is not equal to or larger than the threshold Pstart, the CPU 72 determines that the engine 22 should be stopped continuously, and performs the processings of the aforementioned steps S260 to S300. It should be noted herein that a value in the neighborhood of a lower limit of a power range where the engine 22 can be operated relatively efficiently can be used as the threshold Pstart. However, a value larger than the aforementioned threshold Pstop for stopping the engine 22 may be used to stop the engine 22 from being stopped and started frequently.

In the case where it is determined in step S315 that the vehicle speed V is equal to or higher than the intermittence prohibition vehicle speed Vstart, or even in the case where it is determined in step S315 that the vehicle speed V is not equal to or higher than the intermittence prohibition vehicle speed Vstart, when it is determined in step S320 that the required power Pe* is equal to or larger than the threshold Pstart, the CPU 72 determines that the engine 22 should be started, and sets the torque command Tm1* of the motor MG1 on the basis of a torque map at the time of engine start and an elapsed time t from the beginning of the start of the engine 22 (step S330). The torque map of the torque command Tm1* at the time of engine start is set as a function Tstart(t) based on the elapsed time t from the time of engine start such that the rotational speed Ne of the engine 22 can be rapidly increased immediately after the issuance of a command to start the engine 22 and that the engine 22 can be stably held in a motoring state at a rotational speed equal to or higher than a rotational speed Nref until fuel injection control and ignition control are started. It should be noted herein that the rotational speed Nref is a rotational speed at which fuel injection control and ignition control of the engine 22 are started.

When the torque command Tm1* of the motor MG1 is set, the CPU 72 calculates the provisional torque Tm2tmp as a provisional value of the torque to be output from the motor MG2 according to an expression (10) shown below (step S340) by adding to the required torque Tr* a value obtained by dividing the torque command Tm1* of the motor MG1 by the gear ratio ρ of the motive power distribution/synthesis mechanism 30, calculates the torque limits Tm2 min and Tm2max of the motor MG2 using the aforementioned expressions (7) and (8) (step S350), sets the torque command Tm2* of the motor MG2 (step S360) by limiting the provisional torque Tm2tmp by the torque limits Tm2 min and Tm2max according to the aforementioned expression (9), and sends the set torque commands Tm1* and Tm2* to the motor ECU 40 (step S370).

Tm2tmp=(Tr*+Tm1*/ρ)/Gr (10)

The CPU 72 then determines whether or not the rotational speed Ne of the engine 22 has become equal to or higher than the rotational speed Nref at which fuel injection control and ignition control are started (step S380). Now the time corresponding to the beginning of the start of the engine 22 is taken into account. Therefore, the rotational speed Ne of the engine 22 is low and has not reached the rotational speed Nref. Thus, the CPU 72 makes a negative determination in this step, and terminates the present routine without starting fuel injection control or ignition control.

When the start of the engine 22 is started, the CPU 72 determines in step S310 that the engine 22 is being started, therefore performs the processings of the aforementioned steps S330 to 5380, waits for the rotational speed Ne of the engine 22 to become equal to or higher than the rotational speed Nref at which fuel injection control and ignition control are started (step S380), and sends a control signal to the engine ECU 24 such that fuel injection control and ignition control are started (step S390). Owing to this control, the hybrid automobile 20 can run with the stopped engine 22 being started and with the required torque Tr* output from the motor MG2 to the ring gear shaft 32a as the drive shaft within the range between the input/output limits Win and Wout of the battery 50. FIG. 10 shows an example of an alignment chart showing a mechanical relationship between rotational speed and torque in the rotational elements of the motive power distribution/synthesis mechanism 30 at the time when the vehicle is running with the engine 2 in a motoring state.

According to the hybrid automobile 20 according to the embodiment of the invention described above, the engine 22 is prohibited from being operated intermittently when the vehicle speed V is equal to or higher than the intermittence prohibition vehicle speed, and is permitted to be operated intermittently when the vehicle speed V is not equal to or higher than the intermittence prohibition vehicle speed. In causing the hybrid automobile 20 to run in this manner, the intermittence prohibition vehicle speed is set lower when the running mode is the power mode than when the running mode is the normal speed. Therefore, when the running mode is the power mode, the engine 22 is more often prohibited from being operated intermittently and hence is more often in operation. For this reason, the engine 22 is less often started first even when the large required torque Tr* is required, and the hybrid automobile 20 can run with the required torque Tr* output swiftly. Accordingly, “a feeling of limping along” is less often caused during acceleration, and the responsiveness of a driving force is enhanced. Further; when the running mode is the normal mode, the engine 22 is more often permitted to be operated intermittently and hence can more often be stopped. Accordingly, the engine 22 can more often be stopped when the required power Pe* is small. As a result, no deterioration in fuel economy is caused. Besides, the intermittence prohibition vehicle speed is set to Vstop when the engine 22 is in operation, and to Vstart when the engine 22 is stopped, and the value Vstart is larger than the value Vstop. Therefore, the engine 22 can be prevented from being started and stopped frequently in the case where the hybrid automobile 20 is running in the neighborhood of the intermittence prohibition vehicle speed.

The hybrid automobile 20 according to the embodiment of the invention is equipped with the running mode setting switch 89 to perform control making a changeover between the power mode and the normal mode. However, the hybrid electronic control unit 70 may perform control making a changeover between the power mode and the normal mode in accordance with the running state of the hybrid automobile 20. For example, a changeover between the modes may be made depending on whether or not each of the value of the accelerator operation amount Acc or the amount of change therein and the average of the vehicle speed V or the amount of change therein has exceeded a certain value. Further, it is also appropriate to allow the setting of modes other than the normal mode and the power mode. For example, it is also appropriate to allow the setting of an economy mode in which higher priority is given to fuel economy than in the normal mode.

In the hybrid automobile 20 according to the embodiment of the invention, the values V1 to V4 are constant. However, these values may be set on the basis of another condition. For example, these values may be set on the basis of the input/output limits Win and Wont of the battery 50.

In the hybrid automobile 20 according to the embodiment of the invention, it is determined on the basis of the value Pe* whether to stop the engine 22 or not when the vehicle speed V is not equal to or higher than the intermittence prohibition vehicle speed. However, this determination may be made on the basis of another condition. For example, the determination may be made on the basis of the input/output limits Win and Wout of the battery 50. Further, the engine 22 may always be stopped when the vehicle speed V is not equal to or higher than the intermittence prohibition vehicle speed. Further, the engine 22 may be prohibited from being operated intermittently only when the vehicle speed V is equal to or higher than the intermittence prohibition vehicle speed and another condition is fulfilled. For example, the engine 22 may be prohibited from being operated intermittently only when the vehicle speed V is equal to or higher than the intermittence prohibition vehicle speed and the value Pe* has exceeded a certain threshold.

In the hybrid automobile 20 according to the embodiment of the invention, the value V2 is larger than the value V1, and the value V4 is larger than the value V3. However, the values V2 and V1 may be equal to each other, and the values V4 and V3 may be equal to each other.

In the hybrid automobile 20 according to the embodiment of the invention, the engine 22 is permitted to be operated intermittently when the vehicle speed V is not equal to or higher than the intermittence prohibition vehicle speed Vstop. However, the engine 22 may not be permitted to be operated intermittently when the power mode is set. For example, the value V3 may be a negative value whose absolute value is sufficiently large.

In the hybrid automobile 20 according to the embodiment of the invention, the engine 22 is prohibited from being operated intermittently when the vehicle speed V is equal to or higher than the intermittence prohibition vehicle speed, and is permitted to be operated intermittently when the vehicle speed V is lower than the intermittence prohibition vehicle speed. However, the engine 22 may be prohibited from being operated intermittently when the vehicle speed V is higher than the intermittence prohibition vehicle speed, and may be permitted to be operated intermittently when the vehicle speed V is equal to or lower than the intermittence prohibition vehicle speed.

In the hybrid automobile 20 according to the embodiment of the invention, the torque limits Tm1 min and Tm1max for limiting the provisional torque Tm1tmp of the motor MG1 within the range satisfying the aforementioned expressions (3) and (4) are calculated to set the torque command Tm1* of the motor MG1, and the torque limits Tm2 min and Tm2max are calculated according to the expressions (7) and (8) to set the torque command Tm2* of the motor MG2. However, the motor torque Tm1tmp may be directly set as the torque command Tm1* of the motor MG1 without being limited by the torque limits Tm1min and Tm1max within the range satisfying the expressions (3) and (4), and the torque limits Tm2 min and Tm2max may be calculated, using this torque command Tm1*, according to the expressions (7) and (8) to set the torque command Tm2* of the motor MG2. In addition, any method may be employed as long as the torque commands Tm1* and Tm2* of the motors MG1 and MG2 are set within the range between the input/output limits Win and Wout of the battery 50.

In the hybrid automobile 20 according to the embodiment of the invention, the motor MG2 is mounted on the ring gear shaft 32a as the drive shaft via the reduction gear 35. However, the motor MG2 may be directly mounted on the ring gear shaft 32a. The motor MG2 may also be mounted on the ring gear shaft 32a via a transmission with two speed stages, three speed stages, four speed stages or the like instead of being mounted thereon via the reduction gear 35.

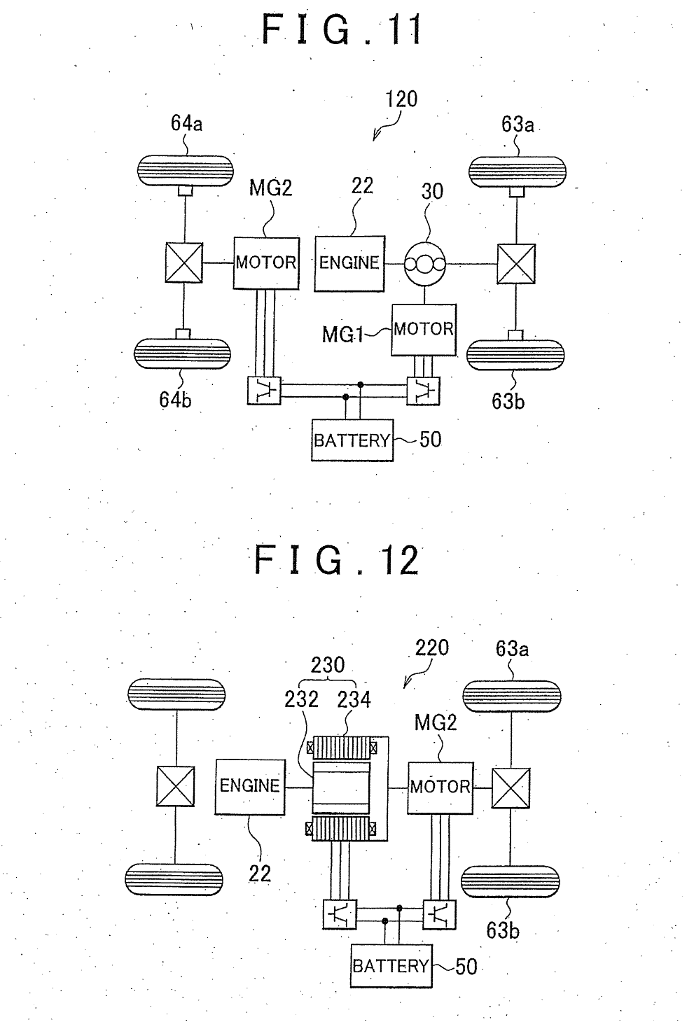

In the hybrid automobile 20 according to the embodiment of the invention, the motive power of the motor MG2 is changed in speed through the reduction gear 35 and output to the ring gear shaft 32a. However, as exemplified as a hybrid automobile 120 according to a modification example of FIG. 11, the motive power of the motor MG2 may be transmitted to an axle (an axle connected to wheels 64a and 64b in FIG. 11) that is different from an axle to which the ring gear shaft 32a is connected (an axle to which the driving wheels 63a and 63b are connected in FIG. 11).

In the hybrid automobile 20 according to the embodiment of the invention, the motive power of the engine 22 is output to the ring gear shaft 32a as the drive shaft connected to the driving wheels 63a and 63b via the motive power distribution/synthesis mechanism 30. However, as exemplified as a hybrid automobile 220 according to another modification example of FIG. 12, the hybrid automobile 220 may be equipped with a paired rotor motor 230, which has an inner rotor 232 connected to the crankshaft 26 of the engine 22 and an outer rotor 234 connected to the drive shaft for outputting motive powers to the driving, wheels 63a and 63b, and transmits part of the motive power of the engine 22 to the drive shaft and converts the rest of the motive power into an electric power.

Further, the invention should not be exclusively applied to the hybrid automobiles as described above. The invention is also applicable to vehicles other than automobiles or methods of controlling such vehicles.

It will now be described how the main elements according to the embodiment of the invention correspond to the main elements according to the invention described in the section of “SUMMARY OF THE INVENTION”. In the embodiment of the invention, the engine 22 may be regarded as “the internal combustion engine”. The motive power distribution/synthesis mechanism 30 and the motor MG1 may be regarded as “the electric power/motive power input/output means”. The motor MG2 may be regarded as “the electric motor”. The battery 50 may be regarded as “the storage means”. The vehicle speed sensor 88 may be regarded as “the vehicle speed detection means”. The hybrid electronic control unit 70, which performs the processing of step S110 in the driving control routine of FIG. 2A to set the required torque Tr* on the basis of the accelerator operation amount Acc and the vehicle speed V, may be regarded as “the required driving force setting means”. The running mode setting switch 89 may be regarded as “the running mode setting means”. The hybrid electronic control unit 70, which executes the intermittence prohibition vehicle speed setting routine of FIG. 3 to set the intermittence prohibition vehicle speeds Vstop and VStart on the basis of the mode setting signal MSW from the running mode setting switch 89, may be regarded as “the vehicle speed threshold setting means”. The hybrid electronic control unit 70, which sets the target rotational speed Ne* of the engine 22 and the target torque. Te* of the engine 22 and sets the torque commands Tm1* and Tm2* of the motors MG1 and MG2 such that the hybrid automobile 20 runs with the engine 22 operated intermittently and with the required torque Tr* output to the ring gear shaft 32a as the drive shaft within the range between the input/output limits Win and Wout of the battery 50 and transmits the set values to the engine. ECU 24 and the motor ECU 40 when the vehicle speed V is not equal to or higher than the intermittence prohibition vehicle speed, and sets the target rotational speed Ne* of the engine 22 and the target torque Te* of the engine 22 and sets the torque commands Tm1* and Tm2* of the motors MG1 and MG2 such that the hybrid automobile 20 runs with the engine 22 prohibited from being operated intermittently so as to be operated continuously and with the required torque Tr* output to the ring gear shaft 32a as the drive shaft within the range between the input/output limits Win and Wout of the battery 50 and transmits the set values to the engine ECU 24 and the motor ECU 40 when the vehicle speed V is equal to or higher than the intermittence prohibition vehicle speed, the engine ECU 24 for controlling the engine 22 on the basis of the target rotational speed Ne* and the target torque Te*, and the motor ECU 40 for controlling the motors MG1 and MG2 on the basis of the torque commands Tm1* and Tm2* may be regarded as “the control means”. Further, the motor MG1 may be regarded as “the electric power generator”. The motive power distribution/synthesis mechanism 30 may be regarded as “the three shaft-type motive power input/output means”. Further, the paired rotor motor 230 may also be regarded as “the electric power/motive power input/output means”.

It should be noted herein that “the internal combustion engine” should not be limited to an internal combustion engine that outputs a motive power using a hydrocarbon-type fuel such as gasoline, diesel oil, or the like. Any type of internal combustion engine, including a hydrogen engine, may be employed as “the internal combustion engine”. “The electric power/motive power input/output means” should not be limited to the combination of the motive power distribution/synthesis mechanism 30 and the motor MG1 or the paired rotor motor 230. Any means that is connected to the drive shaft coupled to the axle and to the output shaft of the internal combustion engine rotatably independently of the drive shaft and can input/output motive powers to/from the drive shaft and the output shaft with an electric power and a motive power input/output may be employed as “the electric power/motive power input/output means”. “The electric motor” should not be limited to the motor MG2 constructed as a synchronous electric power generation motor. Any type of electric motor, including an induction electric motor, may be employed as “the electric motor” as long as a motive power can be input/output to/from the drive shaft. “The storage means” should not be limited to the battery 50 as a secondary battery. Any means, including a capacitor or the like, may be employed as “the storage means” as long as electric powers can be exchanged with the electric power/motive power input/output means or the electric motor. “The vehicle speed detection means” should not be limited to the vehicle speed sensor 88. Any means; including means for calculating the vehicle speed V on the basis of the rotational speed of the ring gear shaft 32a as the drive shaft, means for calculating the vehicle speed V on the basis of signals from wheel speed sensors mounted on the driving wheels 63a and 63b and driven wheels, or the like, may be employed as “the vehicle speed detection means” as long as the vehicle speed is detected. “The required driving force setting means” should not be limited to the means for setting the required torque Tr* on the basis of the accelerator operation amount Acc and the vehicle speed V. Any means, including means for setting the required torque on the basis of only the accelerator operation amount Acc, means for setting the required torque on the basis of a running position on a running route in the case where the running route is set in advance, or the like, may be employed as “the required driving force setting means” as long as a required driving force required for running is set. “The running mode setting means” should not be limited to the running mode setting switch 89. Any means may be employed as “the running mode setting means” as long as a changeover can be made between the normal mode and the power mode in which higher priority is given to the responsiveness of a driving force than in the normal mode. Any type of means may be employed as “the vehicle speed threshold setting means” as long as the vehicle speed threshold as the boundary value between the stop permission vehicle speed range for permitting the internal combustion engine to be stopped and the stop prohibition vehicle speed range for prohibiting the internal combustion engine from being stopped is set on the basis of the running modes. “The control means” should not be limited to the combination of the hybrid electronic control unit 70, the engine ECU 24, and the motor ECU 40. For example, “the control means” may be configured as a single electronic control unit. Further, “the control means” should not be limited to the hybrid electronic control unit 70, which sets the target rotational speed Ne* of the engine 22 and the target torque Te* of the engine 22 and sets the torque commands Tm1* and Tm2* of the motors MG1 and MG2 such that the hybrid automobile 20 runs with the engine 22 operated intermittently and with the required torque Tr* output to the ring gear shaft 32a as the drive shaft within the range between the input/output limits Win and Wout of the battery 50 and transmits the set values to the engine ECU 24 and the motor ECU 40 when the vehicle speed V is not equal to or higher than the intermittence prohibition vehicle speed, and sets the target rotational speed Ne* of the engine 22 and the target torque Te* of the engine 22 and sets the torque commands Tm1* and Tm2* of the motors MG1 and MG2 such that the hybrid automobile 20 runs with the engine 22 prohibited from being operated intermittently so as to be operated continuously and with the required torque Tr* output to the ring gear shaft 32a as the drive shaft within the range between the input/output limits Win and Wout of the battery 50 and transmits the set values to the engine ECU 24 and the motor ECU 40 when the vehicle speed V is equal to or higher than the intermittence prohibition vehicle speed, the engine ECU 24 for controlling the engine 22 on the basis of the target rotational speed Ne* and the target torque Te*, and the motor ECU 40 for controlling the motors MG1 and MG2 on the basis of the torque commands Tm1* and Tm2*. Any means may be employed as “the control means” as long as the internal combustion engine is permitted to be stopped and the internal combustion engine, the electric power/motive power input/output means, and the electric motor are controlled such that the hybrid automobile runs by the driving force based on the set required driving force when the detected vehicle speed is included in the set stop permission vehicle speed range, and the internal combustion engine is prohibited from being stopped and the internal combustion engine, the electric power/motive power input/output means, and the electric motor are controlled such that the hybrid automobile runs by the driving force based on the set required driving force when the detected vehicle speed is included in the set stop prohibition vehicle speed range. “The electric power generator” should not be limited to the motor MG1 configured as a synchronous electric power generation motor. Any type of electric power generator, including an induction electric motor or the like, may be employed as “the electric power generator” as long as a motive power can be input/output. “The three shaft-type motive power input/output means” should not be limited to the aforementioned motive power distribution/synthesis mechanism 30. Any means, including means employing a double pinion-type planetary gear mechanism, means constructed as a combination of a plurality of planetary gear mechanisms and connected to four or more shafts, means having an operation and an effect that are different from those of a planetary gear, such as a differential gear, or the like, may be employed as “the three shaft-type motive power input/output means” as long as the means is connected to the three shafts, namely, the drive shaft, the output shaft, and the rotary shaft of the electric power generator and a motive power is input/output; on the basis of motive powers input/output to/from any two of the three shafts, to/from the other shaft.

The relationship in correspondence between the main elements in the embodiment of the invention and the main elements of the invention described in the section of “SUMMARY OF THE INVENTION” is an example for concretely explaining the best mode for the invention to be implemented according to the embodiment thereof as described in the section of “SUMMARY OF THE INVENTION”, and hence does not limit the elements of the invention described in the section of “SUMMARY OF THE INVENTION”. That is, the invention described in the section of “SUMMARY OF THE INVENTION” should be interpreted on the basis of the description given in this section, and the embodiment of the invention is nothing but a concrete example of the invention described in the section of “SUMMARY OF THE INVENTION”.

Although the best mode for implementing the invention has been described hitherto using the embodiment thereof, the invention should not be limited at all to this embodiment thereof. As a matter of course the invention can be implemented in various forms without departing from the gist thereof.

The invention is available to vehicle manufacturing industries and the like.

1. A hybrid vehicle comprising:
an internal combustion engine;
an electric motor that inputs/outputs a motive power for running;
a storage device that exchanges electric powers with at least the electric motor;
a vehicle speed detection device that detects a vehicle speed;
a required driving force setting device that sets a required driving force required for running;
a running mode setting device that sets a running mode from among a plurality of running modes including a normal mode and a power mode in which higher priority is given to acceleration performance than in the normal mode;
a vehicle speed threshold setting device that sets a vehicle speed threshold, which is a boundary value between a stop permission vehicle speed range for permitting the internal combustion engine to be stopped and a stop prohibition vehicle speed range for prohibiting the internal combustion engine from being stopped, smaller when the power mode is set than when the normal mode is set in setting the vehicle speed threshold on a basis of the running modes; and
a control device that permits the internal combustion engine to be stopped and controls at least the electric motor such that the hybrid vehicle runs by a driving force based on the set required driving force when the detected vehicle speed is included in the set stop permission vehicle speed range, and prohibits the internal combustion engine from being stopped and controls at least the internal combustion engine, and the electric motor such that the hybrid vehicle runs by a driving force based on the set required driving force when the detected vehicle speed is included in the set stop prohibition vehicle speed range.

2. The hybrid vehicle according to claim 1, wherein the vehicle speed threshold setting device sets the vehicle speed threshold smaller when the internal combustion engine is in operation than when the internal combustion engine is stopped.

3. The hybrid vehicle according to claim 9, wherein the electric power/motive power input/output device is equipped with an electric power generator capable of inputting/outputting a motive power, and three shaft-type motive power input/output devices connected to the output shaft of the internal combustion engine, the drive shaft, and a rotary shaft of the electric power generator to input a motive power from one shaft or output a motive power to the one shaft, on a basis of motive powers or output to or input from the other two shafts among the three shafts.

4. The hybrid vehicle according to claim 1, further comprising a running mode setting switch, wherein the running mode setting device sets a running mode in accordance with an operation of the running mode setting switch.

5. The hybrid vehicle according to claim 1, wherein the running mode setting device makes a changeover in the running mode depending on whether or not at least one of a value of an accelerator operation amount, an amount of change in the accelerator operation amount, an average of a vehicle speed V, and an amount of change in the average of the vehicle speed V has exceeded a certain value.

6. The hybrid vehicle according to claim 1, wherein the vehicle speed threshold setting device sets a predetermined vehicle speed threshold for each of the running modes.

7. The hybrid vehicle according to claim 1, wherein the vehicle speed threshold setting device sets the vehicle speed threshold on a basis of input/output limits of a battery.

8. A control method for a hybrid vehicle that includes:
an internal combustion engine;
an electric motor that inputs/outputs a motive power for running;
a storage device that exchanges electric powers with at least the electric motor;
a vehicle speed detection device that detects a vehicle speed; and
a running mode setting device that sets a running mode from among a plurality of running modes including a normal mode and a power mode in which higher priority is given to acceleration performance than in the normal mode, the control method comprising:
setting a vehicle speed threshold, which is a boundary value between a stop permission vehicle speed range for permitting the internal combustion engine to be stopped and a stop prohibition vehicle speed range for prohibiting the internal combustion engine from being stopped, smaller when the power mode is set than when the normal mode is set in setting the vehicle speed threshold on a basis of the running modes; and
permitting the internal combustion engine to be stopped and controlling at least the electric motor such that the hybrid vehicle runs by a driving force based on a required driving force required for running when the detected vehicle speed is included in the set stop permission vehicle speed range, and prohibiting the internal combustion engine from being stopped and controlling at least the internal combustion engine and the electric motor such that the hybrid vehicle runs by a driving force based on the required driving force when the detected vehicle speed is included in the set stop prohibition vehicle speed range.

9. The hybrid vehicle according to claim 1, further comprising:
an electric power/motive power input/output device connected to a drive shaft connected to wheels, and connected to an output shaft of the internal combustion engine rotatable independently of the drive shaft, that inputs motive powers from the drive shaft and the output shaft and outputs motive powers to the drive shaft and the output shaft along with an electric power and a motive power input/output, wherein
the electric power/motive power input/output device exchanges electric powers with the storage device and is controlled by the control device such that the hybrid vehicle runs by a driving force based on the set required driving force.
